(19) United States
(12) Patent Application Publication
(10) Pub. No.: US 2010/0299982 A1
(43) Pub. Date: Dec. 2, 2010

(54) Optical fiber billboard

(75) Inventor: Chu-Yih Yu, Taipei (TW)

Correspondence Address: Yu, Chu-Yhi, P.O. Box 166-13, Taipei, 115, TW

(73) Assignee: Taiwan Plastic Optical Fiber Co., Ltd.

(21) Appl. No.: 12/656,648

(22) Filed: Feb. 12, 2010

(30) Foreign Application Priority Data
May 27, 2009 (TW) 098117799

(51) Int. Cl. G09F 13/18

(52) U.S. Cl. 40/547; 362/559

(57) ABSTRACT

A billboard illuminated by optical fibers is realized by including a framework (1) having plurality outer surfaces (11) for display purpose, multiples optical fibers (2) provided within the framework (1) for guiding light from one surface (11A) to another (11B), and said optical fibers (2) are arranged in a matrix fashion with each optical fiber is spaced by a predetermined space (h) to form a figure or characters, a projecting device (3) placed away from the framework (1) by a predetermined distance (W) as light source, and a cladding (4) applied onto outer surfaces (11) for reinforcing the junction portion where the optical fiber (2) exposed from the outer surfaces (11).

### BACKGROUND OF THE INVENTION

1. Field of the Invention

The present invention relates to an advertising device, more specifically, an advertising billboard illuminated by optical fibers and a light source.

2. Description of Prior Art

Advertising is a form of a communication, sending message to viewers, readers or listeners, to persuade them to take some actions, such as purchasing a product or service of a specific brand. The using of the advertising can be traced back to the Egyptian who used posters or messages. A billboard is an outdoor advertising structure having large size which usually placed in a visible site where lots of viewers will pass by each day, such as alongside the road or hung up in a wall of a building. Some billboards, such as those sited in the time square of New York, have even become the landmarks or tourist spots. For attracting the attention of the viewers, the billboard must be eye-catching, thus colorful and vivid color are commonly used; as for modern billboard, paint is replaced by neon light or LED, allowing the message can be seen during the night time.

### SUMMARY OF THE INVENTION

Aforementioned billboard possesses following drawbacks:
1. For the billboards with painting, neon light or LED, a constant maintenance is necessary. With a high rent for a good location at aside, such maintenance will become an extra burden for the tenant. Thus, to find an advertising structure with less maintenance has become an objective of the present invention.
2. Motion advertising can be display by an electronic or LCD billboard. However, cost for purchasing or renting these types of billboards is relatively high. Besides, electronic devices like theses are delicate and complex and exposing outdoor is usually affected by the weather, such as rain, storm or snow and causing malfunction. Therefore, to invent an outdoor advertising structure with low cost, simple structure, not affecting by the weather and able to display motion advertising has become the second objective of the invention.
3. Most of billboards are limited by its size and shape which is placed, especially when is placed on a wall of the building. The variations and creations are also confined by such limitations. Thus, to design a billboard with less limitation for being more creative has become another objective of the present invention.

To achieve the aforementioned objectives, a billboard is realized by illuminated utilizing multiples optical fibers. Said billboard has two embodiments. In the first embodiment, the billboard is composed of a framework having multiple outer surfaces, plurality of optical fibers passing through the framework for guiding the light emission from one outer surface to another. Each optical fiber consists of a first end, a second end and a light guiding body. Said first and second ends are exposed and provided onto two different outer surfaces of the framework and a layer of Titanium compound is applied to reinforce the junction between the ends and the outer surfaces, while the light guiding body is embedded within the framework for guiding the light. The optical fibers are arranged in a matrix fashion to form a figure or message of the advertisement and each one is spaced by a predetermined distance. Said billboard is lighted by a projecting device, such as a projector, a spot light or an illumination display. The framework of the billboard is primarily to be a wall of the building and the concept is to have a wall incorporates multiple optical fibers, with the light projected from the projecting device, the whole surface of the wall can be utilized for advertising purpose. In the second embodiment, the invention can achieve further the goal of energy-saving by replacing the light from a projecting device with the ambient light, such as the sunlight or the indoor illumination. The second embodiment also can reduce the cost of the device and maintenance.

In comparison with the previous design, the advantages of the present invention are listed as following:
1. The concept of the framework contains multiple optical fibers within illuminated by a projecting device provides an outdoor advertising device with creativity and easy installation. It can be used to display still or motion advertisement by changing the projecting device. No need of heavy machine, such as a crane for lifting the conventional bulletin or complex programming or maintenance for the modern electronic billboard, the present invention saves the installation time and is cost effective.
2. Weather is always the critical factor for the outdoor advertising structure, rain will wash out the painting and damaging the electronic component, the hurricane can blow off the structure and causing casualty. With the device being combined with the outer wall of a building or infrastructure, the human safety is secure and the Titanium compound layer separates the advertising structure from contacting with the outdoor climate, thus the safety is increased and the possibility of malfunction can be reduced.
3. Those billboards or bulletins set outside of the building or skyscraper are offently criticized as they block the light inlet. The optical fiber, as a light guiding element not only can illuminate the advertisement, but also can bring the light toward the space inside the building, reducing the energy consumption of the building. Another innovation point is that the structure is illuminated by a projecting light from a spot light or a projector and a shading effect can be generated if an object or a person passing between the projecting device and the framework. The unexpected shading effect can attract the viewers' attention, achieving the advertising purpose.

### BRIEF DESCRIPTION OF DRAWING

FIG. 1 is a perspective view of the first embodiment of the present invention.

FIG. 2 is a partial enlarged view of the FIG. 1 focusing on the optical fibers.

FIG. 3 is a cross sectional view of the first embodiment of the present invention.

FIG. 4 is a perspective view illustrating the function of the first embodiment of the present invention.

FIG. 5 is an explanatory view illustrating the function of the first embodiment of the present invention with a possible lighting effect.

FIG. 6 is an explanatory view of the first embodiment of the present invention introducing a curved type of installation of the optical fibers.

FIG. 7 is an explanatory view illustrating the function of FIG. 6.

FIG. 8 is a schematic view of the first embodiment of the present invention introducing an intercross type of installation of the optical fibers.

FIG. 9 is an explanatory view demonstrating the function of FIG. 8.

FIG. 10 is a schematic view of the second embodiment of the present invention.

FIG. 11 is an explanatory view illustrating the billboard illuminated by a light bulb.

### DETAIL DESCRIPTION OF PREFERRED EMBODIMENT

The preferred embodiments of the present invention are described in detail hereinafter.

### First Embodiment

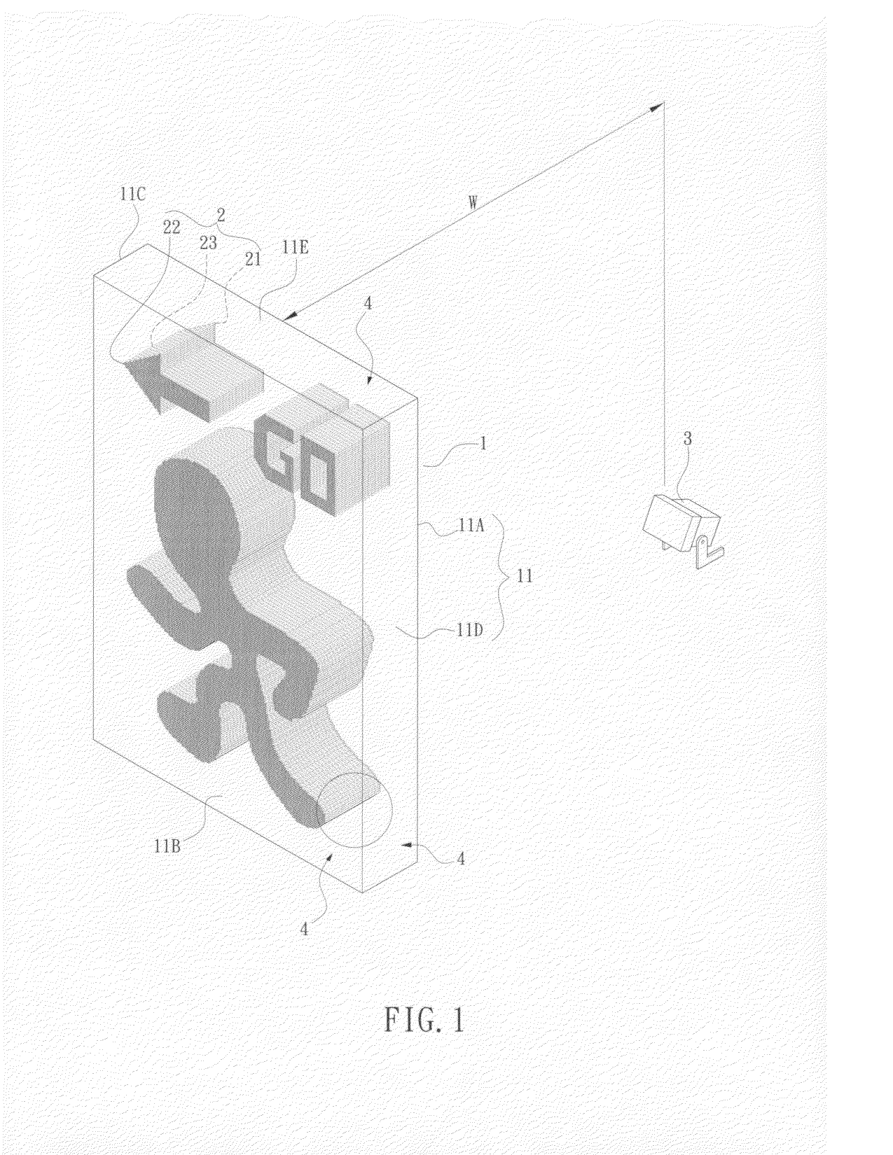

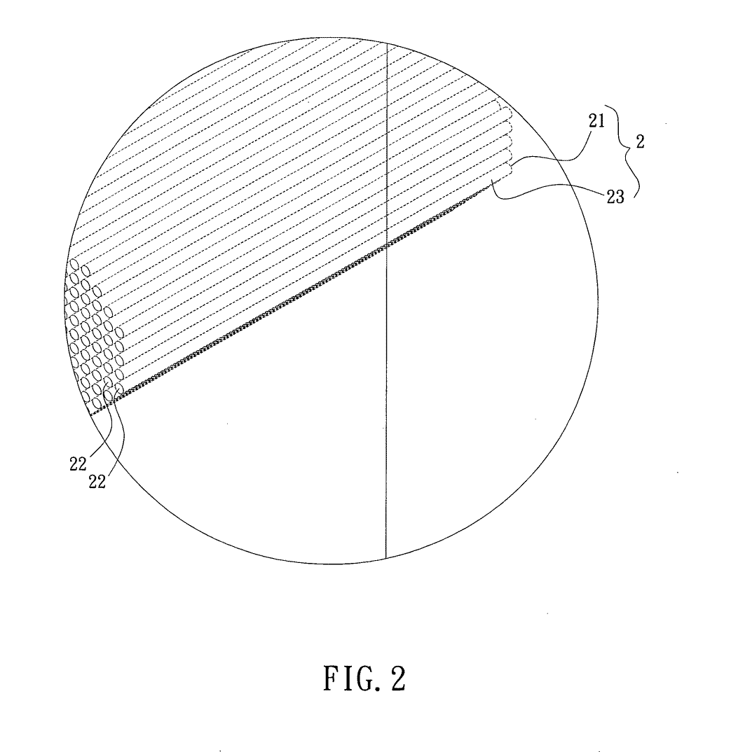

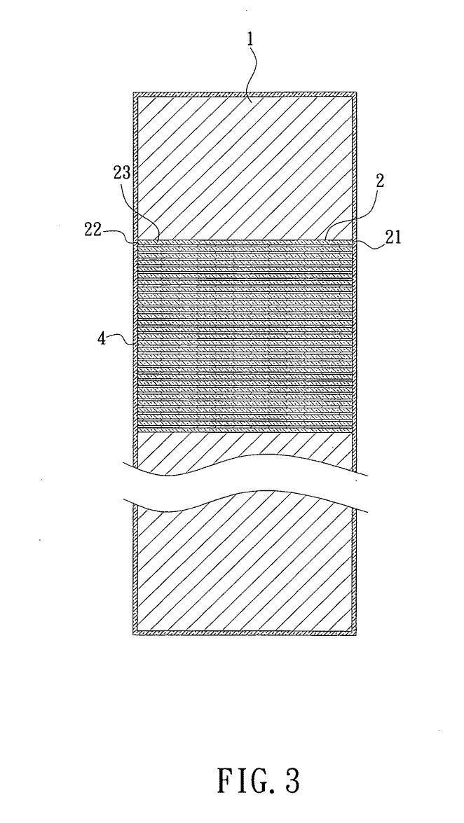

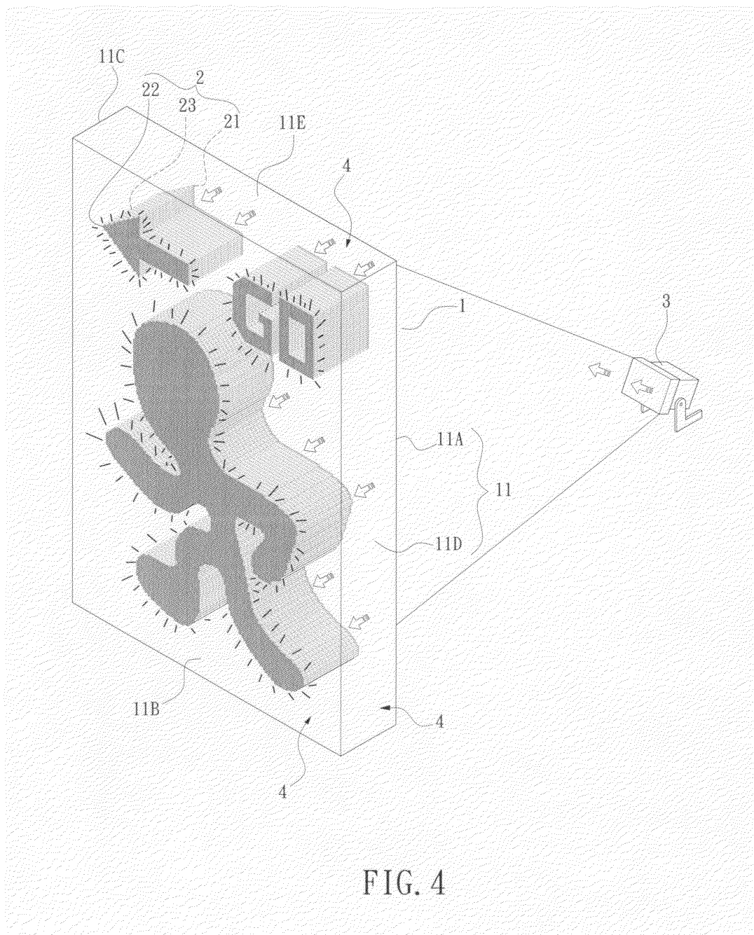

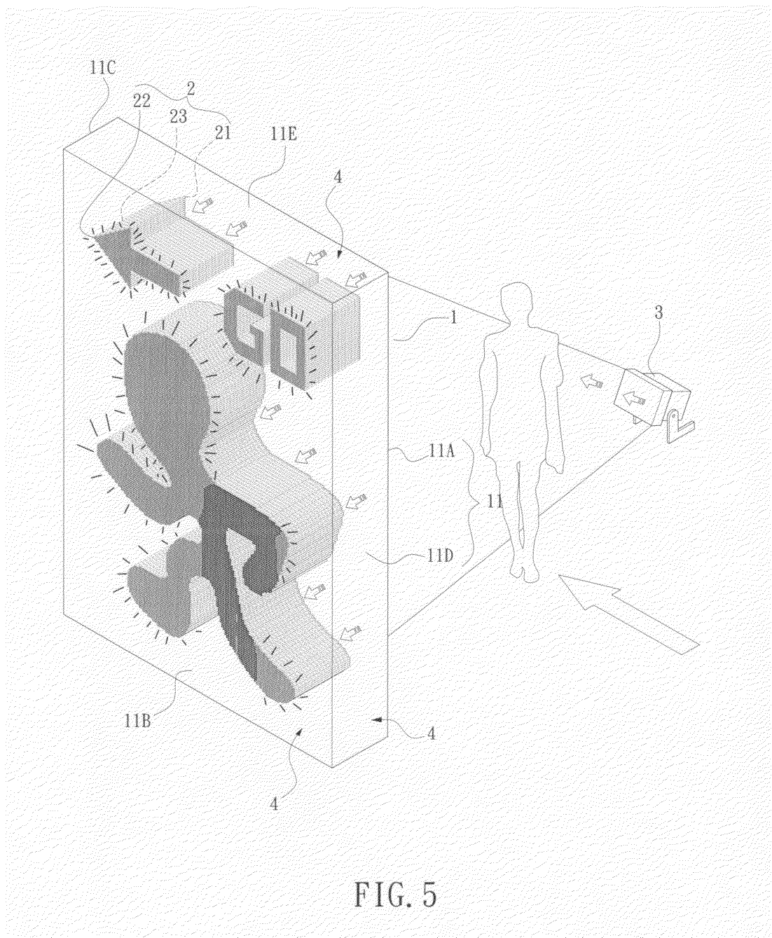

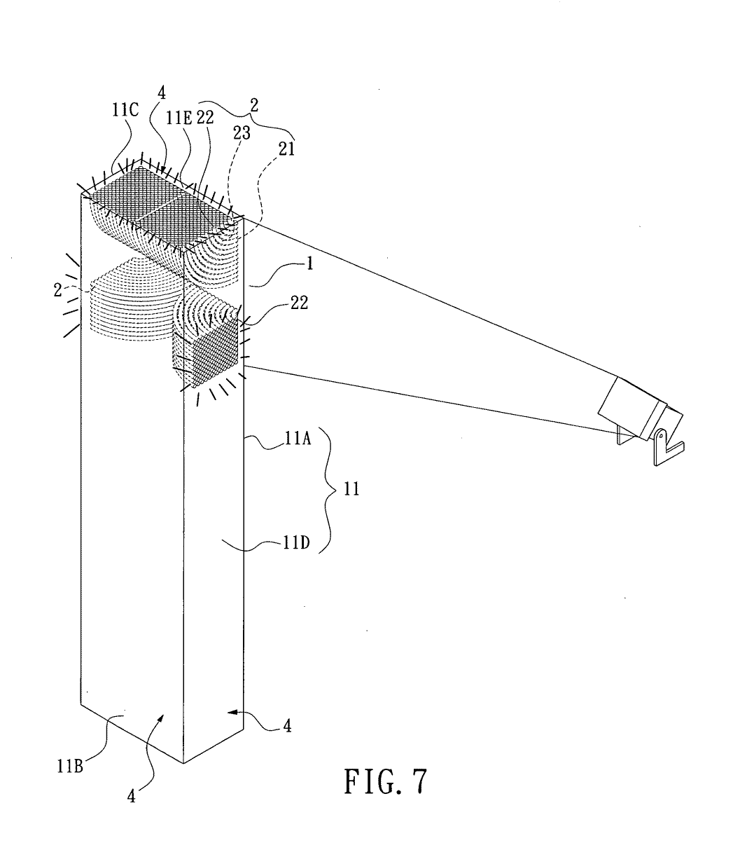

Referring to FIGS. 1-9, a billboard illuminated by optical fiber consists essentially of a framework (1), multiple optical fibers (2) and a projecting device (3). Said framework (1) comprises of plurality of outer surfaces (11) and said optical fibers (2) are incorporated within said framework (1). Each optical fiber (2) includes a first end (21), a second end (22) and a light guiding body (23) between said ends. The optical fibers (2) are incorporated for guiding light from a side of the framework (1) to another side hereof. Said first and second ends (21, 22) of the optical fiber (2) are visible from said surfaces (11) and are arranged in a matrix fashion, spaced with a predetermined distance (h) between each other to form figures or characters. The projecting device (3) is provided at a side of the framework (1) with a projecting distance (W) away from said framework (1), projecting a light to the surface (11) where first ends (21) of said optical fibers (2) are provided. A transparent cladding (4) is applied on each surface (11) for covering said first end (21) and second end (22) of each optical fiber (2), and filling the slit where the optical fiber (2) jointed with the framework (1), securing the optical fiber (2) onto the framework (1).

The optical fibers (2) can soften the light projected from the projecting device (3), reducing the luminous pollution, such as over-illumination or sky-glow. With only needing the electricity for the function of the projecting device (3), the power consumption will decrease gradually.

Unlike the conventional illuminating elements (e.g. light bulb, neon light or LED) which have a service life of thousands of hours, the optical fiber (2), as a light guiding element, has relatively longer life under normal condition. With proper maintenance for the projecting device (3), the advertising structure endures longer than other types of billboards.

Crack or slit may be produced by the different coefficients of expansion of the optical fiber (2) and the framework (1), thus the transparent cladding (4) of Titanium compound or equivalent material is applied for securing and reinforcing the junctions between the optical fiber (2) and the framework (1).

The projecting device (3) which can be utilized for displaying the advertisement can be selected from the multi-color spot light, mono-color spot light, projector or illuminating display (e.g. LED screen, LCD screen). The billboard is designed to be able to display static or motion advertisement, for the static advertisement, such as still imagine, multicolor or mono-color spot light can be utilized, as for commercials or other types of motion advertisements, projector or illumination display can be selected.

The projecting distance (W) can be adjusted depending on the type of the projecting device (3) or size of the framework (1); while the distance (h) is determined according to the required luminous effect and the material of the framework (1).

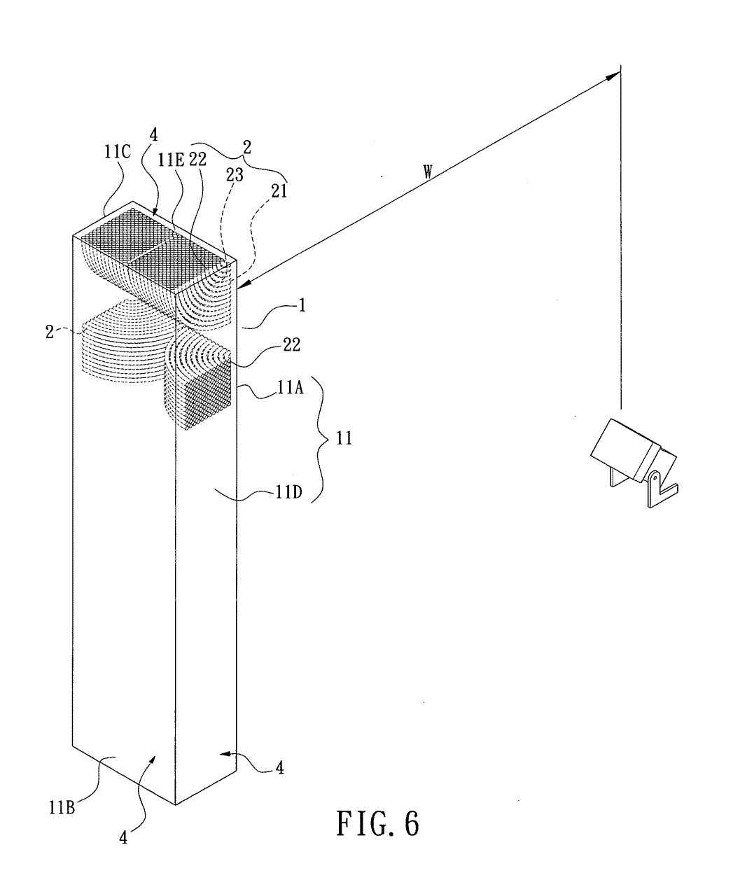

Said first and second ends (21, 22) of each optical fiber (2) are provided on different outer surfaces (11) of the framework (1), and said surfaces (11) can be two at opposite ends facing each other or two adjacent surfaces. Referring to FIGS. 1 and 6, the outer surface (11) includes a rear surface (11A), a frontal surface (11B), a right surface (11C), a left surface (11D) and an upper surface (11E). The light emission can be guided horizontally from the rear surface (11A) to the frontal surface (11B), as illustrated in FIG. 1. As shown in FIG. 6, the optical fiber (2) can also be set in a curved fashion to transmit the light from the rear surface (11A) to the adjacent surfaces (11C, 11D, 11E), creating multi-directional illumination.

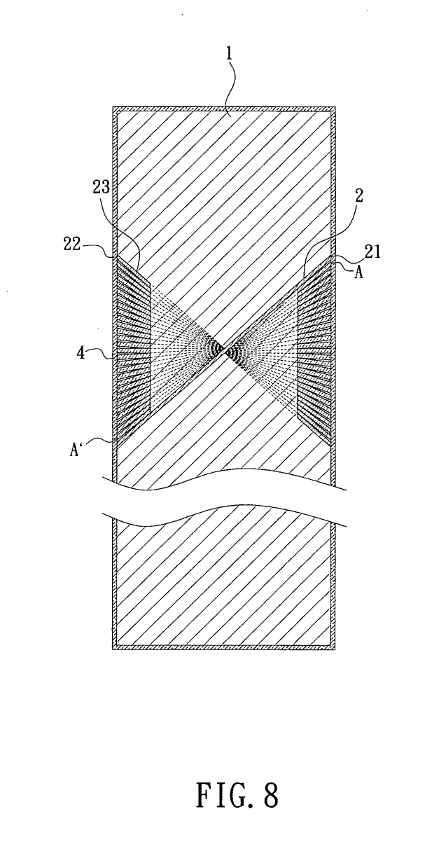

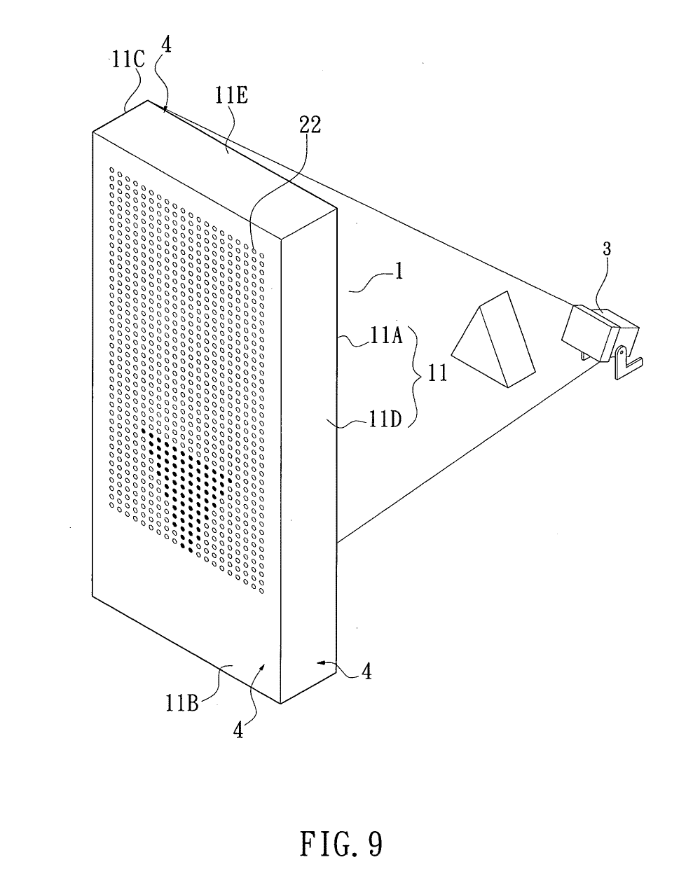

FIGS. 8 and 9 showing an intercross installation of the optical fibers (2), by placing the light-inlet end (A) and light-outlet end (A′) at an intercross fashion, an inverted image will be displayed on the frontal surface (11B).

### Second Embodiment

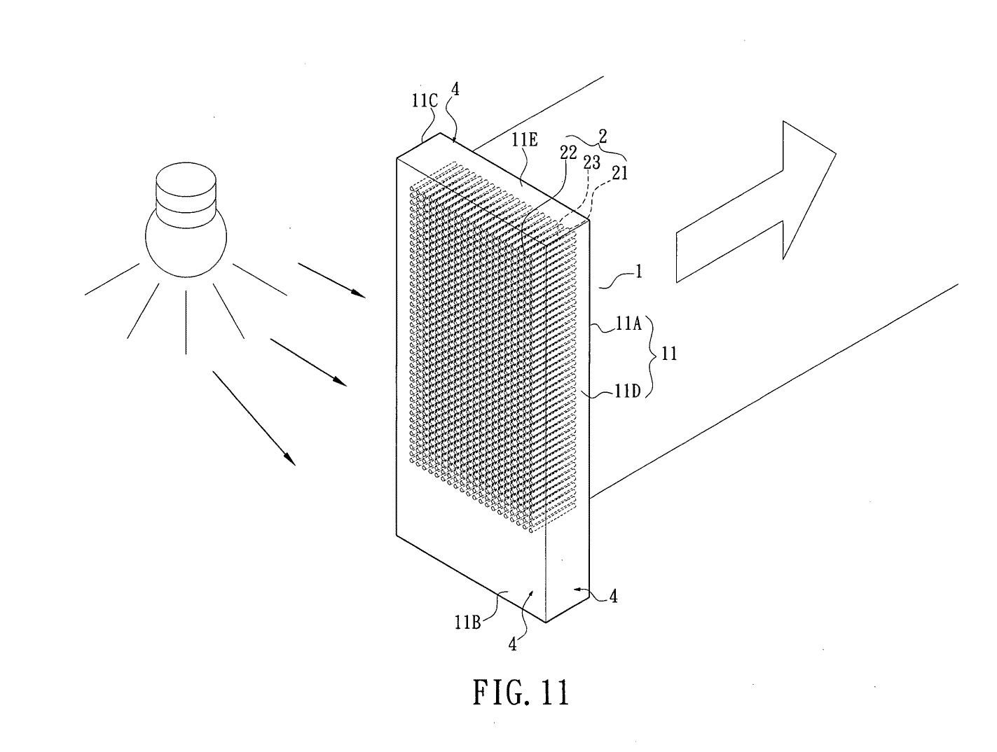

An illustration of the second embodiment is shown in FIGS. 11 and 12. A billboard illuminated by optical fiber consists essentially of a framework (1) and multiple optical fibers (2). The framework (1) comprises of multiple outer surfaces (11) and said optical fibers (2) are incorporated within said framework (1). Each optical fiber (2) includes a first end (21), a second end (22) and a light guiding body (23) between said ends. The optical fibers (2) are incorporated for guiding a light from a side of the framework (1) to another side hereof. Said first and second ends (21, 22) of the optical fiber (2) are visible from said surfaces (11) and are arranged in a matrix fashion, spaced with a predetermined distance (h) between each other to form figures or characters. A transparent cladding (4) is applied on each surface (11) for covering said first end (21) and second end (22) of each optical fiber (2), and for securing the optical fiber (2) onto the framework (1).

It can be noted that the second embodiment of the present invention possesses the same structure for the framework (1) and optical fibers (2), however, the projecting device (3) is replaced by the ambient light, such as sunlight (S) or indoor lighting (e.g. light bulb or fluorescent lamp) to reduce the power consumption of the high-power projector or spot light.

Conventional billboards, whether is electronic or not is made of opaque materials such as fabrics, wood, plastic, thus when said billboards are placed outside, especially on the outer wall of a building, they block the light inlet, increasing the power usage as more lights have to be turned on.

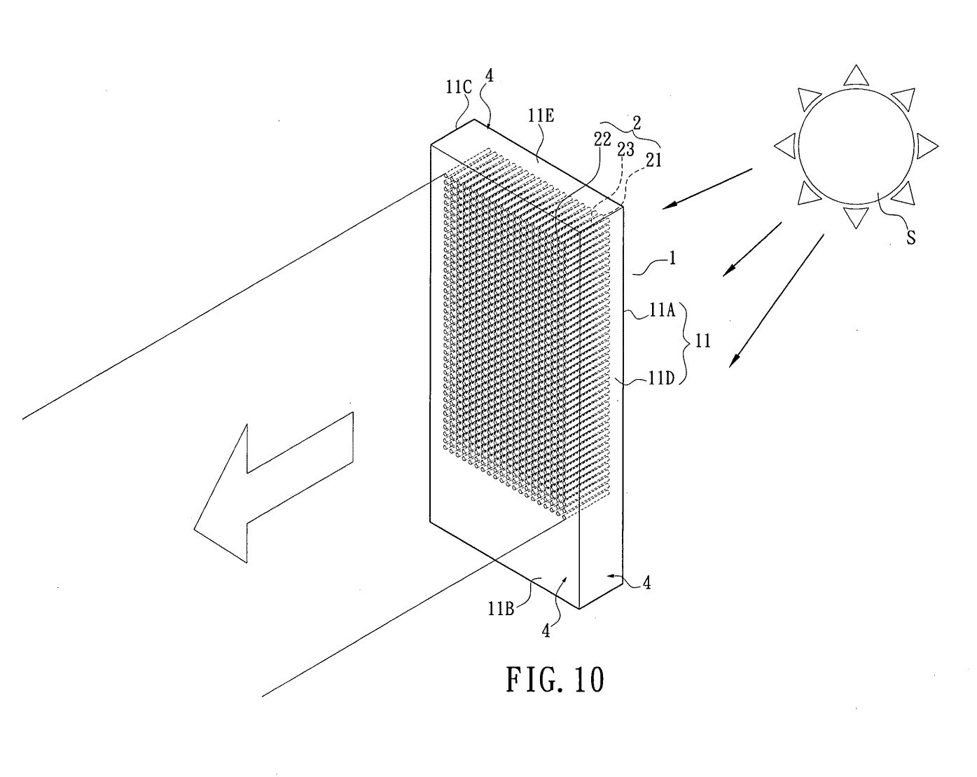

As shown in FIG. 10, by using the optical fibers (2), the sunlight (S) is allowed to enter the room, avoiding unnecessary power waste while the billboard is functioning normally. For the night time, indoor illumination is guided toward outside through the optical fibers (2), functioned similar as the projecting device (3).

The materials for manufacturing the framework (1) as disclosed in both embodiments can be selected from a non-transparent high molecular material, semi-transparent high molecular material, mineral material, concrete, metal or ceramic. The framework (1) can be a billboard, a glass wall or similar material which allows light transmitted therein or an outer wall of a building.

The cladding (4) which contained Titanium compound act as a shield to protect the framework (1) from the weather, and the property of the Titanium can also prevent the structure being soiled by the smoke or air contamination.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. An optical fiber billboard consists essentially of
A framework (1); having a plurality of outer surfaces (11);
A plurality of optical fibers (2) provided within said framework (1); each optical fiber (2) includes a first end (21), a second end (22) and a light guiding body (23) between said ends; said optical fibers (2) are incorporated in said framework (1) for guiding light from a side of the framework (1) to an another side hereof; said first and second ends (21, 22) are exposed and visible from said outer surfaces (11) and are arranged in a matrix fashion spaced by a predetermined distance (h) between each other to form figures or characters;
A projecting device (3) is provided at a side of the framework (1) with a projecting distance (W) away from said framework (1), projecting a light to the surface (11) where first ends (21) of said optical fibers (2) are provided; and
A transparent cladding (4) is applied on each outer surface (11) for covering said first end (21) and second end (22) of each optical fiber (2), and for securing the optical fiber (2) onto the framework (1).

2. The optical fiber billboard of claim 1, wherein said framework (1) is made of one of following: non-transparent high molecular material, semi-transparent high molecular material, mineral material, concrete, metal or ceramic.

3. The optical fiber billboard of claim 1, wherein said framework (1) is a billboard, a glass wall or an outer wall of a building.

4. The optical fiber billboard of claim 1, wherein said projecting device (3) is selected from one of following: a multi-color spot light, a mono-color spot light, a projector or an illuminating panel.

5. The optical fiber billboard of claim 1, wherein said cladding (4) incorporates a titanium compound.

6. The optical fiber billboard of claim 1, wherein said two surfaces (11) where the first and second end of an optical fiber (2) are exposed are facing each other or adjacent.

7. An optical fiber billboard consists essentially of
A framework (1); having a plurality of surfaces (11);
A plurality of optical fibers (2) provided within said framework (1); each optical fiber (2) includes a first end (21), a second end (22) and a light guiding body (23) between said ends; said optical fibers (2) are incorporated in said framework (1) for guiding light from a side of the framework (1) to an another side hereof; said first and second ends (21, 22) are exposed and visible from said outer surfaces (11) and are arranged in a matrix fashion spaced by a predetermined distance (h) between each other to form figures or characters;
A transparent cladding (4) is applied on each outer surface (11) for covering said first end (21) and second end (22) of each optical fiber (2), and for securing the optical fiber (2) onto the framework (1).

8. The optical fiber billboard of claim 7, wherein said framework (1) is made of one of following materials: non-transparent high molecular material, semi-transparent high molecular material, mineral material, concrete, metal or ceramic; said framework (1) is a billboard, a glass wall or an outer wall of a building.

9. The optical fiber billboard of claim 7, wherein said cladding (4) incorporates a titanium compound.

10. The optical fiber billboard of claim 7, wherein said two surfaces (11) where the first and second ends of an optical fiber (2) are exposed are facing each other or adjacent.
